(19) United States
(12) Patent Application Publication
(10) Pub. No.: US 2024/0246281 A1
(43) Pub. Date: Jul. 25, 2024

(54) Method for Producing a Plastic Film from a Total Quantity of Raw Materials in a Film Extrusion Machine, and Computer Program Product for Carrying Out the Method

(71) Applicant: Windmöller & Hölscher KG, Lengerich (DE)

(72) Inventors: Martin Backmann, Lengerich (DE); Markus Bussmann, Lengerich (DE); Wolfgang Hoffmann, Lengerich (DE); Melanie Schuh, Lengerich (DE); Torsten Schmitz, Lengerich (DE)

(21) Appl. No.: 18/560,553

(22) PCT Filed: May 4, 2022
(86) PCT No.: PCT/EP2022/062006

§ 371 Date: Nov. 13, 2023

(30) Foreign Application Priority Data
May 14, 2021 (DE) 10 2021 112 618.5

(51) Int. Cl. B29C 48/92; B29C 48/08

(52) U.S. Cl. CPC B29C 48/92; B29C 48/08; B29C 2948/92114; B29C 2948/92152; B29C 2948/922; B29C 2948/92266; B29C 2948/92285; B29C 2948/92504; B29C 2948/92828

(57) ABSTRACT

The invention relates to a method for producing a plastic film from a total quantity of raw materials in a film extrusion machine. Said method according to the invention comprises the following steps:
providing a selection of raw materials from a total quantity of raw materials,
setting machine and production parameters of the film extrusion machine,
supplying the selection of raw materials to the film extrusion machine in a composition,
detecting at least one actual value of a property of the plastic film,
forming a difference between the actual value and a target value of the property,
changing the selection of raw materials and/or the composition of the raw materials, if the difference exceeds a threshold.

The invention relates to a method for producing plastic film from a total quantity of raw materials using a film extrusion machine, and a corresponding computer program product.

It is known that for the production of plastic film (hereinafter also referred to as “film” for short) with desired properties production parameters are set in film extrusion lines. In the process, a plurality of production parameters is to be considered. For example, temperatures, pressures or other physical variables that act directly on the raw materials, the intermediate products and/or the finished plastic film have to be set at many points. This applies, in particular, to setting, i.e., open-loop and/or closed-loop controlling, the film extrusion line.

The properties of the plastic film produced can be characterized during its production (inline) or subsequently (offline). In particular, the actual fulfillment of a function of the plastic film, but also measurable film parameters such as tear resistance or stretchability of the plastic film, are examined.

In a known production process, first, the required raw materials to be used for producing the desired film are determined based on a formulation. The actual properties of the plastic film are adjusted through settings and subsequent changing of machine and/or production parameters of the film extrusion line. An adjustment to achieve the desired properties, in particular, the quality, is largely based on the experience and knowledge of the operating personnel.

Furthermore, it happens occasionally that the setting limits of the film extrusion line have been reached, but a setting that goes beyond this would be necessary.

Overall, the production of a film with the desired properties can be affected by various influences, which often lead to a reduced quality of the plastic film.

It is the object of the present invention to at least partially eliminate the aforementioned disadvantages. In particular, it is the object of the present invention to propose a process for producing a plastic film with which a plastic film with desired properties, in particular, in a desired quality, can be produced.

The above object is accomplished by a method having the features of Claim 1 and a computer program product having the features of Claim 6. Further features and details of the invention derive from the dependent claims, the description and the figures. Features and details which are described in the context of the method according to the invention naturally also apply in the context of the computer program product according to the invention and vice versa, respectively, so that reference is or can always be made to the individual aspects of the invention reciprocally with respect to the disclosure.

The method according to the invention relates to the production of plastic film from a total amount of raw materials using a film extrusion machine. The method comprises the following steps:
providing a selection of raw materials from a total quantity of raw materials,
setting machine and production parameters of the film extrusion machine,
supplying the selection of raw materials to the film extrusion machine in a composition,
detecting at least one actual value of a property of the plastic film,
forming a difference between the actual value and a target value of the property,
changing the selection of raw materials and/or the composition of the raw materials, if the difference exceeds a threshold.

“Total quantity of raw materials” means different raw material types, to which a user of the film extrusion machine, i.e., the film manufacturer, generally has access to. Typically, these are not only raw materials that the user stores himself for the film production, but also raw materials that the user can procure from raw material suppliers. Thus, the “total quantity” typically comprises a larger number of raw material types than processed simultaneously on a single film extrusion machine.

From this total quantity of raw materials a selection is then made and provided for production. In particular, more than a sufficient quantity of each raw material type is available so that the planned quantity of film according to the formulation is actually produced.

Also, the machine and production parameters of the film extrusion machine are to be set. Machine parameters can include, for example, components that can be mechanically set such as a circumferential speed of take-off rollers or a diameter and/or a position of a calibration cage. Production parameter can be temperatures, electrical voltages or air flow rates. Such parameters are often specified in a formulation for the production of the desired film.

In a further step, the selection of raw materials is then supplied to the film extrusion machine in a composition, which is typically specified by the formulation. Today's plastic film is generally a multi-layer film, whereby several raw material types are often used for one layer. These raw material types are in a fixed mixing ratio in known production processes. However, it is also possible that there are several layers of the same composition with in the film. In this case, too, for each of said layers, the raw materials are separately supplied by respectively associated supply means, which typically are designed as dosing devices, in order to be able to maintain the mixing ratio.

During film production, numerous properties are monitored through various measuring methods and an actual value with regard to at least one property is detected. Said actual value is then used to determine a difference to the associated target value. If the difference results in a value that exceeds a previously defined threshold, an intervention is then carried out to bring the difference back below the threshold value.

It is a core idea of the invention to adjust the selection of raw materials and/or the composition of the raw materials, if the difference exceeds a threshold. The threshold may be specified by the formulation or it may be defined by the user. The latter may even be the case multiple times during the film production.

That is to say, the invention substantially provides not to adjust the machine and/or production parameters of the film extrusion machine during a production in progress, but, in particular, to vary the mixing ratios of the raw materials. It may, for example, also be provided to add a further raw material type to a layer or to replace a raw material type with another raw material type within a layer. Omitting a raw material type within a film layer is also conceivable.

The invention further comprises that the thickness of the individual layers is being varied. This means that one layer can be produced to be thicker in favor of another layer, whereby the composition of the raw materials, i.e., their mixing ratios can remain constant in the individual layers.

A further improvement of the invention can be achieved, if at least one raw material is associated with the property of the plastic film based on a film production model. Within the film production model, it is provided to associate one or more raw material types and, in particular their properties, with a property of the plastic film. The properties of the plastic film and the raw materials are thus correlated. This simplifies and speeds up the process of keeping or bringing the difference below the threshold. On the other hand, the film production model may be designed as a self-learning system, with the formed correlation being continually improved to be able to predict the influence of changing the selection of raw materials and/or their composition on the film, or to be able to determine and carry out the selection of suitable raw materials and/or the composition more precisely and quickly.

Further advantages are achieved with the method according to the invention if the machine and production parameters of the film extrusion machine are maintained or substantially maintained. This way, the film production can be carried out independently from the knowledge and the experience of the machine operator. However, maintaining the parameters does not mean the adjustments that ensure that the set parameters, which have been determined on the basis of setpoint values, also match the actual value within tolerance limits during prolonged operation. One example here is the temperature of the film bubble before it cools down to below the solidification temperature. This temperature gradient is very sensitive to external influences.

In an advantageous realization of the invention, it is provided that at least one of the following steps is carried out for detecting the property of the plastic film:
determining the blow or film shape
determining the frost line position within the film extrusion line
determining the total thickness of the plastic film
determining the thickness variation of the plastic film across its width
determining the thickness of at least one individual layer of the film
determining the viscosity of a melted-on raw material
determining the number of fish eyes in the plastic film
determining the Young's modulus of the plastic film
determining the tear resistance of the plastic film

This list of possible steps is not exhaustive and therefore does not represent a restriction. The listed determinations can be made directly, such as determining the bubble or film shape, which can be done, in particular, using a camera. However, the listed determinations can also be made indirectly. For example, the frost line position can be determined through a temperature measurement of the film.

The bubble or film shape, which is measured in particular between the point where the hot melt leaves the extrusion die for extrusion and the frost line where the film solidifies, can be used to detect symmetry errors, for example. The position of the frost line itself, i.e., the distance of the frost line to the extrusion die, is in some cases strongly dependent on the raw materials used and can therefore be used to advantage. Another option is measuring the total thickness of the plastic film and, in particular, the thickness variation of the film across its width to be able to determine deviations from the average thickness of the film. Measuring the thickness of individual layers is also advantageous. Furthermore, the viscosity of the melted-on raw materials can be measured, wherein the melted-on raw materials each form an individual layer in the film. As already described further up, these melts may contain several individual raw materials so that the viscosity of the melted-on raw materials, which have formed a mixture of the individual raw materials for the respective layer at the time of the measurement, can be measured. The viscosity can have an influence on the thickness of the film, but also on the thickness of the individual layers. The viscosity can also be a decisive factor for the cooling behavior of the film. Measuring properties of the finished film, such as the number of fish eyes as a measure of the frequency of defects, Young's modulus and also the tear resistance of the film, can also form the basis for the method according to the invention.

A realization of the invention, in which the plastic film comprises at least one layer which is created from several raw materials, wherein a main raw material and at least two ancillary raw materials are used, wherein changing the selection of raw materials and/or the composition of the raw materials substantially relates to the ancillary raw materials, is advantageous.

The main raw material is understood to be a raw material that has a relative percentage that is greater than the relative percentage of any other raw material. Consequently, it is provided in the further development to keep the percentage of the main raw material constant while the percentages of the ancillary raw materials are kept variable.

Also the subject of the present invention is a computer program product comprising instructions which, when the program is executed on a computer, cause the computer to carry out the steps of a method according to the invention. Thus, a computer program product according to the invention has the same advantages as those explained in detail with reference to a method according to the invention.

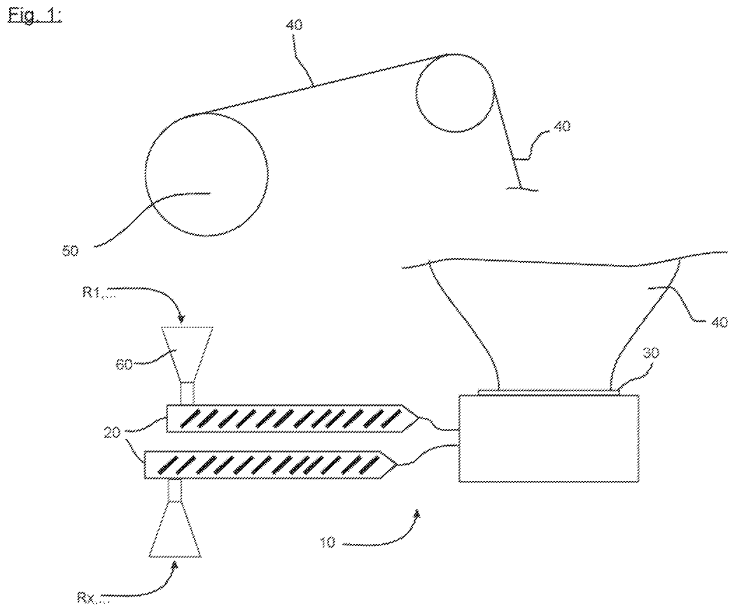

FIG. 1 schematic illustration of a film extrusion machine,

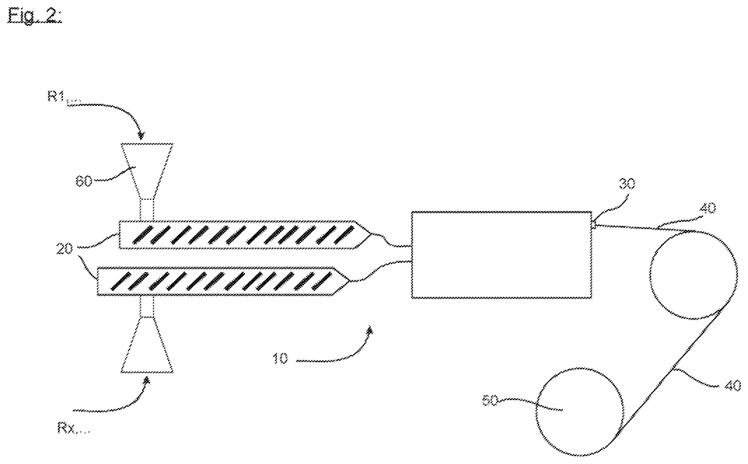

FIG. 2 schematic illustration of a different film extrusion machine,

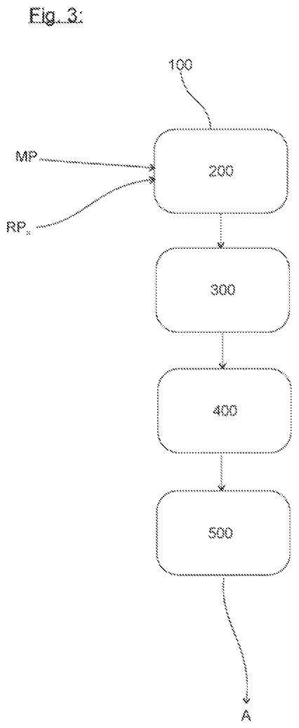

FIG. 3 schematic illustration of the sequence of a method according to the invention.

In FIGS. 1 and 2, film extrusion machines 10 are shown by way of example. The film extrusion machines have in common that they are equipped with extruders 20. Each individual extruder supplies the film extrusion machines with melted plastic material for a layer of the subsequent film. For this purpose, a first extruder is supplied with one or more raw materials R1, . . . via metering devices 60, a second extruder is supplied with one or more raw materials Rx . . . in said manner. The raw materials are generally provided in the form of plastic granulate. The type and/or quantity of the supplied raw materials are predetermined by the method according to the invention.

The method according to the invention can be carried out using a cast film or a blown film extrusion line as shown in FIG. 2.

FIG. 1 shows a blown film line comprising the already described extruders 20. A film web or film 40 for short is discharged from the die 30, the die 30 being designed as an annular blow die. The film web is initially formed as a bubble which is later laid flat. Said film, which now comprises two individual films placed one on top of the other, is wound counter-clockwise onto one winding roller 50 or, after cutting, onto two winding rollers.

The film extrusion machine in FIG. 2 is a cast film extrusion machine, which, as an example, is also equipped with two extruders 20 for different compositions. A film web 40 is discharged from the die 30, which film web cools down on a cooling roller and is subsequently wound onto a winding roller 50.

FIG. 3 schematically shows the process of the method according to the invention. A memory and computing unit 100 is provided with film parameters FP relating to the desired properties of the film and raw material parameters RPn relating to the properties of the raw materials. The index n of the raw material parameters RP indicates that this is an entirety of raw materials from which one or more raw materials are selectable. First a grouping of the raw material parameters into at least two raw material parameter groups is carried out in the memory and computing unit, which is illustrated through the reference sign 200. In two subsequent steps, which may be carried out in any order or simultaneously, correlations are formed between raw material parameter groups 300, and correlations are formed between film parameters and the raw material parameter groups 400 based on a film production model which is stored and/or executed within the memory and computing unit. In the subsequent step 500, a selection of at least one raw material from at least one raw material parameter group is detected.

After the control and computing unit 100 has calculated at least one production parameter PP of the film extrusion machine based on the film production model, the production parameter of the film extrusion machine is output.

### REFERENCE SIGN LIST

10 Film extrusion machine
20 Extruder
30 Die
40 Film web
50 Wound roll
60 Dosing device
100 Memory and computing device
FPM Film production model

1. A method for producing a plastic film from a total quantity of raw materials in a film extrusion machine, comprising the following steps:
providing a selection of raw materials from a total quantity of raw materials,
setting machine and production parameters of the film extrusion machine,
supplying the selection of raw materials to the film extrusion machine in a composition,
detecting at least one actual value of a property of the plastic film,
forming a difference between the actual value and a target value of the property,
changing the selection of raw materials and/or the composition of the raw materials if the difference exceeds a threshold.

2. The method according to according to claim 1, additionally comprising the following step:
associating at least one raw material with the property of the plastic film based on the film production model.

3. The method according to according to claim 1, additionally comprising the following step:
maintaining the machine and production parameters of the film extrusion machine.

4. The method according to claim 1, wherein one of the following steps is carried for detecting the property of the plastic film:
determining the bubble shape
determining the frost line position within the film extrusion line
determining the total thickness of the plastic film
determining the thickness variation of the plastic film across its width
determining the thickness of at least one individual layer of the film
determining the viscosity of a melted-on raw material
determining the number of fish eyes in the plastic film
determining the Young's modulus of the plastic film
determining the tear resistance of the plastic film.

5. The method according to claim 1, wherein the plastic film comprises at least one layer which is created from several raw materials, wherein a main raw material and at least two ancillary raw materials are used, wherein changing the selection of raw materials and/or the composition of the raw materials substantially relates to the ancillary raw materials, wherein, in particular, the main raw material accounts for at least 51% of the total raw material.

6. A computer program product comprising instructions which, when the program is executed on a computer, cause the computer to carry out the steps of a method comprising the features of claim 1.
